(19) United States
(12) Patent Application Publication
(10) Pub. No.: US 2018/0248931 A1
(43) Pub. Date: Aug. 30, 2018

(54) WEB PAGE CONTENT THAT IS ONLY ACCESSABLE AND VIEWABLE ON MOBILE DEVICES AND NOT ON DESKTOPS AND LAPTOPS

(71) Applicant: William Taylor, Carlsbad, CA (US)

(72) Inventor: William Taylor, Carlsbad, CA (US)

(21) Appl. No.: 15/408,491

(22) Filed: Feb. 28, 2017

(51) Int. Cl. H04L 29/08; H04L 12/24

(52) U.S. Cl. CPC H04L 67/02; H04L 41/20

(57) ABSTRACT

A system and method for providing webpage content on a mobile device that is only accessible and viewable on a mobile device and not on a desktop or laptop. The web page content to be accessed and viewed on a mobile device only is placed between code that facilitates the device to recognize that it's a mobile device and not a desktop or laptop by restricting access and view- ability to desktops and laptops to the web page content that is targeted for mobile devices only. On the webpage a start mobile device only code is placed before the mobile device content to be viewed on mobile devices only and an end mobile device only code is placed after the mobile device only content.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a diagrammatic illustration of a method of blocking webpage content to desktops and laptops by Inserting a start mobile device only code/desktop and laptop blocking code before the webpage content and then inserting the end mobile device only code/desktop and laptop blocking after the webpage content making it accessible and viewable by mobile devices only;

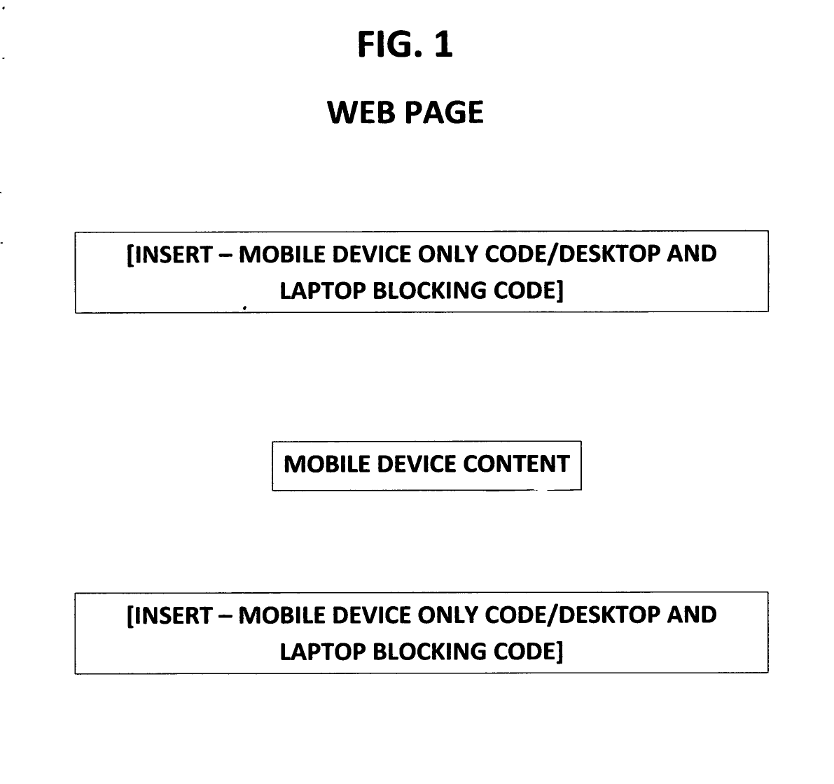

### BACKGROUND OF THE INVENTION

The emergence and popularity of mobile computing has made portable electronic devices, due to their compact design and light weight, a staple in today's marketplace. As a result, program developers are constantly creating content (e.g., applications, etc.) for smartphones and tablets. For most mobile devices, however, it is difficult to access and open multiple mobile applications, contact specific users on social media applications by simply clicking on an icon or link, access to previously unknown users accounts on mobile applications, easily switch between mobile applications on one subject or user, view other users on their social media profiles, mobile device specific communication tools, mobile device social media content pertaining to a user's needs and interest in a non-mobile application with a convenient, fast loading single location and with a non-downloadable requirement as mobile applications currently have and with the ability to share easier. A webpage with content designed specifically for mobile devices only is the solution but the problem with webpage content it is normally accessed by all desktops, mobile devices and laptops. To access webpages content designed specifically for mobile devices by desktops and laptops will cause confusion and security risks because of the webpage content being mobile device specific with confidential information, user social media information, links, mobile device specific tools and mobile applications. By restricting the webpage content to be only accessible and viewable by mobile devices by blocking content being accessed and viewed on desktops and laptops solves this problem.

### BRIEF SUMMARY OF THE INVENTION

Method and System for accessing a Web Page with content that can only be accessed and viewed on Mobile Devices and not on Desktops and Laptops.

### BRIEF DESCRIPTION OF THE INVENTION

Embodiments of the present invention disclose a method and system for providing access to a webpage with content only accessible and viewable with a mobile device and not on laptops and desktops. The web page content to be accessed and viewed on a mobile device is placed between code that facilitates the device to recognize that it's a mobile device and not a desk top restricting access and view ability of the web page content that is targeted for mobile devices only.

What is claimed is:

1. A method of enabling a webpage with content to be viewable and accessible by mobile devices only and with webpage content being blocked for desktops and laptops making webpage content not accessible and not viewable on desktops and laptops; To block webpage content to desktops and laptops by inserting a start mobile device only program code/desktop and laptop blocking code before the webpage content and then inserting the end mobile device only program code/desktop and laptop blocking program code after the webpage content making it accessible and viewable by mobile devices only.

2. The method of claim 1, further comprising: the program code used on the webpage identifies the device being used to access/view the webpage content and either grants access and view ability to the webpage content or blocks the webpage content being accessed and viewed.

3. The method of claim 1, further comprising: the web page content to be accessed and viewed on a mobile device is placed between program code that facilitates the device to recognize that it's a mobile device and not a desk top restricting access and view ability of the web page content that is targeted for mobile devices only.

4. The method of claim 1, further comprising: To block webpage content to mobile tablets, desktops and laptops by inserting a start mobile phone only code/mobile tablet, desktop and laptop blocking code before the webpage content and then inserting the end mobile phones only code/mobile tablets, desktop and laptop blocking code after the webpage content making it accessible and viewable by mobile phones only.

5. The method of claim 1, further comprising: To block webpage content to mobile phones, desktops and laptops by inserting a start mobile tablet only code/mobile phone, desktop and laptop blocking code before the webpage content and then inserting the end mobile tablets only code/mobile phones, desktop and laptop blocking code after the webpage content making it accessible and viewable by mobile tablets only.
